(19) United States
(12) Patent Application Publication
(10) Pub. No.: US 2011/0281016 A1
(43) Pub. Date: Nov. 17, 2011

(54) PREPARED FEED FOR A RUMINANT AND A METHOD FOR PREPARING THE FEED AND A DIGESTION ENHANCING FORAGE MATERIAL

(75) Inventors: David Ellison Beever, Buckingshamshire (GB); Anthony Charles Hall, Canastota, NY (US); Gerard Keenan, Carlow (IE); John Joseph McCurdy, Kilkenny (IE)

(73) Assignee: SALFORD ENGINEERING LIMITED, Borris, County Carlow (IE)

(21) Appl. No.: 12/993,176

(22) PCT Filed: May 27, 2009
(86) PCT No.: PCT/IE2009/000029

§ 371 Date: May 5, 2011

(30) Foreign Application Priority Data
May 27, 2008 (IE) S2008/0420

(51) Int. Cl. A23K 1/18

(52) U.S. Cl. 426/623; 426/648; 426/630; 426/442

(57) ABSTRACT

A prepared feed for a ruminant is produced by mixing a plurality of ingredients, at least one of which is a forage material. At least some of the forage material acts to enhance digestion of the prepared feed by the ruminant. The digestion enhancing forage material typically comprises one or more of hay, straw, silage and other stalky material, and constitutes in the range of I00 gms to 550 gms per kg prepared feed. The digestion enhancing forage material of the prepared feed comprises fibres of length in the range of 30 mm to 50 mm and has a primary saturation extent in the range of the order of 680 mls to 820 mls water per litre of digestion enhancing forage material, an uncompressed specific gravity of the order of I 00 gms to 220 gms per litre and a first compression specific gravity of the order of 140 gms to 290 gms per litre and a second compression specific gravity of the order of 150 gms to 500 gms per litre. This produces a prepared feed of primary saturation extent in the range of 675 mls to 735 mls water per litre of prepared feed, an uncompressed specific gravity in the range of 200 gms to 280 gms per litre, a first compression specific gravity in the range of 180 gms to 300 gms per litre and a second compression specific gravity in the range of 270 gms to 430 gms per litre. The first and second compression specific gravities are determined by subjecting the digestion enhancing forage material and the prepared feed to respective first and second downward forces of 2.41 kg and 7.41 kg in a vertical cylindrical container of diameter of 75 mm. The digestion enhancing forage material forms a uniform homogenous low density open matrix which extends throughout the rumen liquor within the rumen with particulate and other nutritional ingredients as well as other forage material dispersed throughout the matrix and retained therein for optimising the dwell time of the nutritional and other fibrous ingredients within the rumen for in turn maximising the production of intermediary products which subsequently promoting weight gain and/or milk yield in a ruminant.

The present invention relates to a prepared feed for a ruminant, and to a method for preparing the feed, and the invention also relates to a daily feed ration for a ruminant. The invention also relates to a digestion enhancing forage material.

The term “forage” as used throughout this specification is to be understood to mean any edible fibrous crop material, including, for example, silages, such as grass or maize, hays, such as cereal, legume or grass hays and the like, straws, such as cereal, legume or canola/rape straws, corn stalks and stovers, and any other edible stalky material.

Weight gain in ruminants such as calves, cattle, sheep and goats, and milk yield from ruminants, such as cows, sheep and goats, are a function of a number of aspects of the feed as fed to the ruminant. Nutritional value of the feed is of fundamental importance to providing weight gain and milk yield, and in particular, to increasing weight gain and milk yield, as well as improving meat and milk composition. However, unless the ruminant can convert the nutritional value of the feed to weight gain or milk yield efficiently, the benefits of much of the nutritional value of a feed is lost. In fact, it has been found that many feeds which are high in nutritional value do not to the extent to which they should convert to weight gain and milk yield in ruminants. This, thus, is a serious problem, since ingredients which are high in nutritional value tend to be the more expensive, and thus, if a ruminant is not adequately converting the nutritional value of ingredients to weight and milk gain, the nutritional value of the feed has to be further increased in order to obtain a desired weight gain or milk yield. This adds significantly to the cost of feeds, and in turn significantly increases the cost per unit of meat or unit of milk produced by a ruminant. This is undesirable and is unsustainable in the long term.

There is therefore a need for a prepared feed for a ruminant, and a method for producing such a prepared feed which addresses this problem.

The present invention is directed towards providing such a prepared feed and a method for producing the prepared feed. The invention is also directed towards a daily feed ration for a ruminant, and the invention is also directed towards a digestion enhancing forage material, and to a method for feeding an animal.

According to the invention there is provided a prepared feed for a ruminant produced by mixing a plurality of ingredients, the prepared feed comprising forage material, and at least some of the forage material acting to enhance digestion of the prepared feed by the ruminant, the proportion of the digestion enhancing forage material in the prepared feed being such that the prepared feed has:
a primary saturation extent in the range of 675 mls water per litre of prepared feed to 735 mls water per litre of prepared feed,
an uncompressed specific gravity in the range of 200 gms per litre to 280 gms per litre, and
a first compression specific gravity in the range of 180 gms per litre to 300 gms per litre when subjected to a first downward compressive force of 2.41 kg in a vertically oriented cylindrical container having an internal diameter of 75 mm.

In one embodiment of the invention the prepared feed has a second compression specific gravity in the range of 270 gms per litre to 430 gms per litre when subjected to a second downward compressive force of 7.41 kg in the vertical cylindrical container of internal diameter of 75 mm.

It is also preferable that the uncompressed specific gravity of the prepared feed after wetting thereof resulting from the test to determine the primary saturation extent of the prepared feed should lie in the range of 590 gms per litre to 660 gms per litre.

The primary saturation extent of the prepared feed is determined by taking a representative sample of the prepared feed and placing a volume of one litre of the representative sample of the prepared feed in a vertically oriented graduated cylindrical container of internal diameter of 100 mm and length of 290 mm. The one litre volume of the sample is determined by filling the graduated cylinder to the one litre level of the container. The graduated container is filled to the one litre level with the sample of the prepared feed without any compressing, compacting or aerating of the sample in the container with the sample retaining its normal consistency. Water is then gradually added to the container to the one litre level thereof, with air being released from the sample as the water is being added. The water is maintained at the one litre level in the container until bubbling of released air from the sample of prepared feed ceases. Finally, the volume of water added to the container is recorded. The recorded volume of water added to the container is deemed to be the primary saturation extent of the prepared feed in millilitres water per litre prepared feed.

The uncompressed specific gravity of the prepared feed is determined by taking a representative sample of the prepared feed, and filling a vertically oriented graduated cylindrical container of internal diameter of 75 mm and length of 374 mm with the sample to the one litre level without any compressing, compacting or aerating of the sample in the container with the sample retaining its normal consistency. The sample in the container is weighed to produce the uncompressed specific gravity in gms per litre.

The first compression specific gravity of the prepared feed is determined using the same sample in the vertically oriented graduated cylindrical container of internal diameter of 75 mm and of length of 374 mm which was used for determining the uncompressed specific gravity of the prepared feed. With the sample occupying the container up to the one litre level without any compressing, compacting or aerating of the sample with the sample retaining its normal consistency. A piston which is vertically slideable in the container is placed in the container over the sample, and a weight is placed on the piston such that the combined weight of the piston and the weight is equal to a first compression weight of 2.41 kg. The force of the first weight acting on the sample in the container compresses the sample within the container. The compressed volume of the sample is determined, and since the weight of the sample is already known, the first compression specific gravity is expressed in gms per litre based on the compressed volume of the sample under the first compression weight.

The second compression specific gravity is determined from the sample in the container from which the first compression specific gravity is determined by adding an additional weight to the piston, so that the combined weight of the piston and the weights is equal to a second compression weight of 7.41 kg. The compressed volume of the sample under the second weight is determined, and the second compression specific gravity is expressed in gms per litre based on the compressed volume of the sample under the second compression weight.

The uncompressed specific gravity of the wetted prepared feed is determined from the sample of the prepared feed from which the primary saturation extent is determined. The water is drained from the sample, which is then weighed, and since the volume of the sample is already known, the uncompressed specific gravity of the wetted prepared feed is expressed in gms per litre of the wetted sample of the prepared feed.

Preferably, the uncompressed specific gravity of the prepared feed lies in the range of 210 gms per litre to 260 gms per litre. Advantageously, the uncompressed specific gravity of the prepared feed is of the order of 230 gms per litre.

Preferably, the first compression specific gravity of the prepared feed lies in the range of 220 gms per litre to 290 gms per litre. Advantageously, the first compression specific gravity of the prepared feed is of the order of 270 gms per litre.

Preferably, the second compression specific gravity of the prepared feed lies in the range of 280 gms per litre to 340 gms per litre. Advantageously, the second compression specific gravity of the prepared feed is in the order of 330 gms per litre.

Preferably, the uncompressed specific gravity of the wetted prepared feed lies in the range of 600 gms per litre to 640 gms per litre. Advantageously, the uncompressed specific gravity of the wetted prepared feed is in the order of 630 gms per litre.

Preferably, the primary saturation extent of the prepared feed lies in the range of 675 mls water per litre of prepared feed to 725 mls water per litre prepared feed.

Advantageously, the primary saturation extent of the prepared feed is in the order of 700 ml water per litre of prepared feed.

It is preferable that the length of fibres of the forage material of the prepared feed should not exceed 100 mm.

Preferably, the length of the fibres of the forage material of the prepared feed lie in the range of 25 mm to 90 mm, and advantageously, in the range of 30 mm to 80 mm.

In one embodiment of the invention the length of some of the fibres of the forage material of the prepared feed lie in the range of 30 mm to 50 mm, and preferably, the length of the fibres of the forage material of the prepared feed lies in the range of 30 mm to 50 mm.

In another embodiment of the invention the length of some of the fibres of the forage material of the prepared feed lie in the range of 50 mm to 80 mm, and preferably, the length of the fibres of the forage material of the prepared feed lies in the range of 50 mm to 80 mm.

In an alternative embodiment of the invention the length of some of the fibres of the forage material of the prepared feed lies in the range of 25 mm to 50 mm.

Where the prepared feed is prepared for feeding to fully grown ruminants, in particular, cows, cattle and the like with relatively large muzzles, the lengths of the fibres of the forage material of the prepared feed will be of the longer range, while in prepared feeds for smaller ruminants, for example, calves, sheep, goats and the like, with relatively small muzzles, the length of the fibres of the forage material of the prepared feed will be of the shorter ranges.

Preferably, the digestion enhancing forage material constitutes in the range of 100 gms per kg of prepared feed to 550 gms per kg of prepared feed.

In order to determine if the prepared feed comprises the digestion enhancing forage material to an amount within the appropriate range, a representative sample of the prepared feed is subjected to a winnowing procedure. In the winnowing procedure the representative sample of the prepared feed is allowed to drop vertically through a horizontally directed airstream produced by means of a 200 mm axial flow fan delivering 0.225M³ air per second. The lighter elements of the sample material are deflected outwardly from the vertical path by the horizontal airstream. The material from the sample which is only deflected outwardly a distance of not more than 100 mm from the vertical path by the horizontal airstream is discounted as being unsuitable (too heavy) to constitute digestion enhancing forage material. Material which is deflected distances greater than 700 mm from the vertical path by the horizontal airstream is also discounted, since it is considered to be too light to constitute digestion enhancing forage material. The material which is deflected from the vertical path by the horizontal airstream distances within the range of 100 mm to 700 mm of the vertical path is collected in a sieve as being of weight or other suitable characteristic which could constitute digestion enhancing forage material. The sieve is perforated with perforations of 19 mm diameter to allow non-fibrous material and fibrous material of length 19 mm and less to pass therethrough. Before undertaking further characterisation of the collected material, the collected material is lightly sieved in the sieve, and the proportion of the representative sample of the prepared feed which is constituted by the collected sample is then determined. If the proportion of the representative sample of the prepared feed which is constituted by the collected sample is within the required range, then the collected sample is subjected to further tests, which will be described below, in order to confirm that the material of the collected sample is digestion enhancing forage material.

The primary saturation extent of the collected sample collected during the winnowing procedure is determined in a similar manner as is the primary saturation extent of the prepared feed determined. An appropriate sized sample is taken from the collected sample which is collected during the winnowing procedure and the primary saturation extent of that sample is determined.

Preferably, the primary saturation extent of the digestion enhancing forage material lies in the range of 680 mls per litre of digestion enhancing forage material to 820 mls per litre of digestion enhancing forage material.

Advantageously, the primary saturation extent of the digestion enhancing forage material lies in the range of 720 mls water per litre of digestion enhancing forage material to 800 mls water per litre of digestion enhancing forage material. Ideally, the primary saturation extent of the digestion enhancing forage material is of the order of 760 mls water per litre of digestion enhancing forage material.

The uncompressed specific gravity of the collected sample collected during the winnowing procedure is determined in a similar manner as the uncompressed specific gravity of the prepared feed is determined. An appropriately sized sample of the collected sample collected during the winnowing procedure is taken for determining the uncompressed specific gravity of the collected sample.

Preferably, the uncompressed specific gravity of the digestion enhancing forage material lies in the range of 100 gms per litre to 220 gms per litre.

Advantageously, the uncompressed specific gravity of the digestion enhancing forage material lies in the range of 100 gms per litre to 180 gms per litre. Ideally, the uncompressed specific gravity of the digestion enhancing forage material is in the order of 130 gms per litre.

The first and second compression specific gravities of the collected sample collected during the winnowing procedure are determined in a similar manner as the first and second compression specific gravities of the prepared feed are determined. An appropriately sized sample is taken from the collected sample obtained during the winnowing procedure for determining the first and second compression specific gravities of the collected sample.

Preferably, the digestion enhancing forage material has a first compression specific gravity in the range of 140 gms per litre to 290 gms per litre when the digestion enhancing forage material is subjected to the first downward compressive force of 2.41 kg in the vertically oriented cylindrical container having an internal diameter of 75 mm.

Preferably, the digestion enhancing forage material has a second compression specific gravity in the range of 150 gms per litre to 500 gms per litre when the digestion enhancing forage material is subjected to the second downward compressive force of 7.41 kg in the vertically oriented cylindrical container having an internal diameter of 75 mm.

Advantageously, the first compression specific gravity of the digestion enhancing forage material lies in the range of 160 gms per litre to 240 gms per litre. Ideally, the first compression specific gravity of the digestion enhancing forage material is in the order of 180 gms per litre.

Advantageously, the second compression specific gravity of the digestion enhancing forage material lies in the range of 200 gms per litre to 300 gms per litre. Ideally, the second compression specific gravity of the digestion enhancing forage material is in the order of 230 gms per litre.

The uncompressed specific gravity of the wetted collected sample collected during the winnowing procedure is determined in a similar manner as the uncompressed specific gravity of the wetted prepared feed is determined. The specific gravity of the wetted sample of the collected sample collected during the winnowing procedure, which was wetted in order to determine the primary saturation extent of the collected sample is used for determining the uncompressed specific gravity thereof.

Preferably, the uncompressed specific gravity of the digestion enhancing forage material of the prepared feed after wetting thereof resulting from a test to determine the primary saturation extent of the digestion enhancing forage material lies in the range of 530 gms per litre to 740 gms per litre.

Advantageously, the uncompressed specific gravity of the wetted digestion enhancing forage material lies in the range of 600 gms per litre to 680 gms per litre. Ideally, the uncompressed specific gravity of the wetted digestion enhancing forage material is in the order of 640 gms per litre.

If the primary saturation extent of the collected sample falls outside the relevant required ranges of the primary saturation extent for the digestion enhancing forage material, the prepared feed may be deemed not to comprise an adequate amount of digestion enhancing forage material.

If the uncompressed specific gravity of the collected sample falls outside the relevant required ranges of the uncompressed specific gravity for the digestion enhancing forage material, the prepared feed may be deemed not to comprise an adequate amount of digestion enhancing forage material.

If the first compression specific gravity of the collected sample falls outside the relevant required ranges of the first compression specific gravity for the digestion enhancing forage material, the prepared feed may be deemed not to comprise an adequate amount of digestion enhancing forage material.

If the second compression specific gravity of the collected sample falls outside the relevant required ranges of the second compression specific gravity for the digestion enhancing forage material, the prepared feed may be deemed not to comprise an adequate amount of digestion enhancing forage material.

If the uncompressed wetted specific gravity of the collected sample falls outside the relevant required ranges of the uncompressed wetted specific gravity for the digestion enhancing forage material, the prepared feed may be deemed not to comprise an adequate amount of digestion enhancing forage material.

The proportion of the prepared feed which constitutes the digestion enhancing forage material is deemed to be the proportion of the representative sample of the prepared feed constituted by the collected sample which is collected during the winnowing procedure provided that the primary saturation extent of the collected sample lies in the range of 680 mls to 820 mls water per litre of the collected sample, and preferably that the uncompressed specific gravity of the collected sample lies in the range of 100 gms per litre to 220 gms per litre, and advantageously that the first compression specific gravity of the collected sample lies in the range of 140 gms per litre to 290 gms per litre.

The prepared feed is preferable when the digestion enhancing forage material complies with the narrower ranges of the primary saturation extent, the uncompressed specific gravity and the first compression specific gravity. Indeed, the prepared feed produces even better results when the second compression specific gravity of the digestion enhancing forage material lies in the range of 150 gms per litre to 500 gms per litre, and it is preferable that the second compression specific gravity should lie in the range of 160 gms/litre to 240 gms/litre. Furthermore, the prepared feed produces even better results when the uncompressed specific gravity of the wetted digestion enhancing forage material lies in the range 530 gms per litre to 740 gms per litre, and preferably, lies in the range of 600 gms per litre to 680 gms per litre.

Preferably, the digestion enhancing forage material constitutes in the range of 180 gms per kg of prepared feed to 240 gms per kg of prepared feed. Ideally, the digestion enhancing forage material constitutes in the order of 210 gms per kg of prepared feed. However, it will be appreciated that the proportion of the digestion enhancing forage material in the prepared feed may vary to some extent from one class type of ruminant to another.

Preferably, the digestion enhancing forage material is stalky material.

It has been found that the digestion enhancing forage material when it is of good structural form, and in particular, when it is of good structural stalky form, significantly contributes to producing the digestion enhancing forage material to be within the desired range of uncompressed specific gravity, first compression specific gravity and second compression specific gravity, as well as providing that the digestion enhancing forage material is within the desired range of primary saturation extent and wetted uncompressed specific gravity. Additionally, by producing the digestion enhancing forage material to be within the desired ranges of uncompressed specific gravity, first compression specific gravity, second compression specific gravity and primary saturation extent and uncompressed wetted specific gravity in general provides the prepared feed to be within the desired ranges of primary saturation extent, uncompressed specific gravity, first compression specific gravity and second compression specific gravity and wetted uncompressed specific gravity.

Ideally, the digestion enhancing forage material is derived from one or more of the following forage ingredients:
cereal straws
legume straws
canola/rape straws
cereal hays
legume hays
grass hays
corn stalks/stover
other suitable stalky materials according to local availability.

Preferably, the length of the fibres of the digestion enhancing forage material of the prepared feed lie in the range of 25 mm to 90 mm, and advantageously, in the range of 30 mm to 80 mm.

In one embodiment of the invention the length of some of the fibres of the digestion enhancing forage material of the prepared feed lie in the range of 30 mm to 50 mm, and preferably, the length of the fibres of the forage material of the prepared feed lies in the range of 30 mm to 50 mm.

In another embodiment of the invention the length of some of the fibres of the digestion enhancing forage material of the prepared feed lie in the range of 50 mm to 80 mm, and preferably, the length of the fibres of the digestion enhancing forage material of the prepared feed lies in the range of 50 mm to 80 mm.

In an alternative embodiment of the invention the length of some of the fibres of the digestion enhancing forage material of the prepared feed lies in the range of 25 mm to 50 mm.

Where the prepared feed is prepared for feeding to fully grown ruminants, in particular, cows, cattle and the like with relatively large muzzles, the lengths of the fibres of the digestion enhancing forage material of the prepared feed will be of the longer range, while in prepared feeds for smaller ruminants, for example, calves, sheep, goats and the like, with relatively small muzzles, the length of the fibres of the digestion enhancing forage material of the prepared feed will be of the shorter ranges.

In one embodiment of the invention the prepared feed is adapted for feeding to a lactating cow, and in an alternative embodiment of the invention the prepared feed is adapted for feeding to a dry cow. In a further, alternative embodiment of the invention the prepared feed is adapted for feeding to a beef producing animal.

The invention also provides a digestion enhancing forage material for a prepared feed for a ruminant, the digestion enhancing forage material having:
a primary saturation extent in the range of 680 mls water per litre of prepared feed to 820 mls water per litre of prepared feed,
an uncompressed specific gravity in the range of 100 gms per litre to 220 gms per litre, and
a first compression specific gravity in the range of 140 gms per litre to 290 gms per litre when subjected to a first downward compressive force of 2.41 kg in a vertically oriented cylindrical container having an internal diameter of 75 mm.

The invention also provides a method for producing a prepared feed for a ruminant, the method comprising mixing a plurality of ingredients of which at least one of the ingredients comprises forage material, and at least some of the forage material acts to enhance digestion of the prepared feed by the ruminant, the proportion of the digestion enhancing forage material in the prepared feed being such that the prepared feed has:
a primary saturation extent in the range of 675 mls water per litre of prepared feed to 735 mls water per litre of prepared feed,
an uncompressed specific gravity in the range of 200 gms per litre to 280 gms per litre, and
a first compression specific gravity in the range of 180 gms per litre to 300 gms per litre when subjected to a first downward compressive force of 2.41 kg in a vertically oriented cylindrical container having an internal diameter of 75 mm.

In one embodiment of the invention the ingredients are mixed in a mixing apparatus comprising a container defining a hollow interior region having a mixing rotor rotatable therein about a substantially horizontally extending rotational axis, the mixing rotor comprising at least one mixing paddle carried on an arm extending radially therefrom, the mixing paddle extending in a general axial direction relative to the rotational axis of the rotor.

In one embodiment of the invention the ingredients are subjected to a mixing cycle of not more than 320 revolutions of the mixing rotor in the mixing apparatus during mixing thereof. Preferably, the ingredients are subjected to a mixing cycle in the range of 80 revolutions to 320 revolutions of the mixing rotor in the mixing apparatus during mixing thereof. Advantageously, the ingredients are subjected to a mixing cycle in the range of 100 revolutions to 140 revolutions of the mixing rotor in the mixing apparatus during mixing thereof.

Preferably, at least some of the forage material is chopped during mixing thereof to produce the digestion enhancing forage material of the prepared feed.

In one embodiment of the invention the mixing apparatus comprises a chopping means for reducing the length of fibrous materials during mixing thereof.

Ideally, the ingredients of the prepared feed are mixed in a mixing apparatus of the type disclosed in PCT Published Application Specification No. WO 96/32836 of the present applicant.

The invention also provides a daily feed ration for a ruminant comprising not more than 45 gms dry matter of the prepared feed according to the invention per kg live weight of the ruminant. Preferably, the daily feed ration for the ruminant lies in the range of 20 gms to 40 gms dry matter of the prepared feed per kg live weight of the ruminant. Advantageously, the daily feed ration for a ruminant lies in the range of 25 gms to 30 gms dry matter of the prepared feed per kg live weight of a ruminant of live weight in the range 100 kg to 300 kg. Advantageously, the daily feed ration for a ruminant is of the order of 25 gms dry matter of the prepared feed per kg live weight of a ruminant of live weight in the range of 100 kg to 300 kg.

In another embodiment of the invention the daily feed ration for a ruminant comprises in the range of 20 gms to 25 gms dry matter of the prepared feed per kg live weight of a ruminant of live weight in the range of 300 kg to 500 kg. Advantageously, the daily feed ration for a ruminant comprises in the order of 22.5 gms dry matter of the prepared feed per kg of live weight of a ruminant of live weight in the range of 300 kg to 500 kg.

In another embodiment of the invention the daily feed ration for a ruminant comprises in the range of 30 gms to 40 gms dry matter of the prepared feed per kg of live weight of a lactating ruminant. Advantageously, the daily feed ration comprises 30 gms to 40 gms dry matter of the prepared feed per kg of live weight of a lactating ruminant of live weight in the range of 550 kg to 650 kg. Preferably, the daily feed ration comprises in the order of 35 gms dry matter of the prepared feed per kg of live weight of a lactating ruminant of live weight in the range of 550 kg to 650 kg.

In a further embodiment of the invention the daily feed ration for a ruminant comprises in the range of 20 gms to 30 gms dry matter of the prepared feed per kg live weight of the ruminant of a beef producing ruminant of live weight in the range of 400 kg to 500 kg. Preferably, the daily feed ration comprises in the range of 25 gms dry matter per kg of live weight of the ruminant of a beef producing ruminant of live weight in the range of 400 kg to 500 kg.

The invention also provides a method for feeding a ruminant comprising feeding the daily feed ration according to the invention to the ruminant per day.

The advantages of the prepared feed according to the invention are many. It has been found that the prepared feed according to the invention optimises the period during which nutritional ingredients are retained in the rumen of the ruminant. This, thus, maximises the conversion of the nutritional ingredients to intermediary products in the rumen which subsequently promote weight gain or milk yield, as the case may be. Such nutritional ingredients tend to be particulate type ingredients and typically are relatively small dense particles, which can be discharged relatively rapidly from the rumen after ingestion when a ruminant is fed prior art feeds. It is important that such nutritional ingredients as well as other nutritional ingredients are retained in the rumen for the necessary period of time until they have been fully converted to the intermediary products which promote weight gain or milk yield, as the case may be. It has been found that the digestion enhancing forage material of the prepared feed is a bulky type of material and forms a three-dimensional uniform homogenous low density open matrix without stratification within the rumen liquor within the rumen. This low density open matrix of the digestion enhancing forage material entraps and retains the smaller nutritional particulate ingredients and smaller fibre ingredients within the liquor of the rumen, and thereby prevents their premature discharge from the rumen.

Additionally, the fact that the digestion enhancing forage material forms a homogenous low density open matrix which extends throughout the rumen liquor within the rumen, both rumination rates and extents of the ruminant are increased, thereby increasing saliva production, which in turn maintains the pH of the rumen liquor at a pH at or above 6.0 for longer periods of time, thereby further improving conversion of the nutritional ingredients to the intermediary products. Furthermore, by virtue of the fact that the digestion enhancing forage material of the prepared feed forms a uniform homogenous low density open matrix without stratification within the rumen facilitates further mixing of the prepared feed within the rumen which is effected by rumen movements, which are initiated in the reticulum at the front of the rumen. Since the smaller nutritional particulate ingredients and the smaller fibre ingredients, as well as other nutritional ingredients are retained entrapped within the low density open matrix formed by the digestion enhancing forage material, as the prepared feed is being mixed in the rumen within the rumen liquor, the entrapped nutritional particles and other materials, as well as the small fibre ingredients remain entrapped within the low density open matrix, and are continuously being exposed to enzymes and microflora in the rumen liquor so that conversion of the nutritional ingredients by the enzymes and the microflora to the intermediary products which subsequently promote weight gain or milk yield, as the case may be, is maximised. By virtue of the fact that the pH of the rumen liquor is maintained at or above 6.0 for longer periods of time by the increased rate and extent of rumination, the action of the enzymes and microflora in the rumen liquor on the nutritional ingredients is optimised.

By virtue of the fact that the digestion enhancing forage material of the prepared feed according to the invention facilitates better and more complete digestion of the prepared feed, less methane gas is produced by the ruminant per unit of weight gain or milk yield, and furthermore, less manure is produced by the ruminant per unit of weight gain or milk yield.

By providing the digestion enhancing forage material of the prepared feed to be of an uncompressed specific gravity in the range of 100 gms per litre to 220 gms per litre, and preferably, in the range of 100 gms per litre to 180 gms per litre, it has been found that the digestion enhancing forage material is relatively bulky, and thus bulks out the prepared feed. Thus, once the prepared feed is homogenously mixed, the uncompressed specific gravity of the prepared feed lies in the range of 200 gms per litre to 280 gms per litre. This thus facilitates the formation of the prepared feed into the low density open matrix by the digestion enhancing forage material, which extends throughout the contents of the rumen with the remaining ingredients of the prepared feed retained within the matrix.

By producing the prepared feed with the digestion enhancing forage material having a first compression specific gravity in the range of 140 gms per litre to 290 gms per litre, and preferably, in the range of 160 gms per litre to 240 gms per litre and a second compression specific gravity in the range of 150 gms per litre to 500 gms per litre, and preferably, in the range of 200 gms per litre to 300 gms per litre, a prepared feed with a particularly bulky digestion enhancing forage material is produced, which in turn further bulks out the prepared feed, so that the first and second compression specific gravities of the prepared feed lie in the ranges 180 gms per litre to 300 gms per litre and 270 gms per litre to 430 gms per litre, respectively, and preferably, in the respective ranges of 220 gms per litre to 290 gms per litre and 280 gms per litre to 340 gms per litre. This, thus, further enhances the formation of the homogenous low density open matrix of the digestion enhancing forage material throughout the contents of the rumen with the other ingredients of the prepared feed dispersed throughout and retained entrapped in the low density open matrix.

By producing the prepared feed with the digestive enhancing forage material having a primary saturation extent in the range of 680 mls water per litre of digestion enhancing forage material to 820 mls water per litre of digestion enhancing forage material and preferably, in the range of 720 mls to 800 mls water per litre of digestion enhancing forage material further improves the bulk of the digestion enhancing forage material, and in turn the bulking of the prepared feed, and results in the prepared feed having a primary saturation extent in the range of 675 mls water per litre of prepared feed to 725 mls water per litre of prepared feed. This in turn ensures that the homogenous low density open matrix of the digestion enhancing forage material extends throughout the contents of the rumen with the other ingredients of the prepared feed dispersed and retained within the matrix.

The digestion enhancing forage material of the prepared feed is ideally stalky material, and is provided ideally by the stalky parts of silage, hay, straw and the like, and preferably, the lengths of the stalky material should not exceed 100 mm, and preferably, should lie within the range 25 mm to 90 mm, and advantageously, within the range 30 mm to 80 mm for a fully grown lactating or dry cow or beef cattle. However, for smaller ruminants of smaller muzzle size, the length of the stalky material of the digestion enhancing forage material would typically be in the range of 25 mm to 50 mm. The stalky material should also be of good structural integrity in order to optimise the formation of the low density open matrix of the digestion enhancing forage material throughout the rumen liquor within the rumen, and ideally, the structure of the stalky material should be such that deformation of the material during mixing of the prepared feed should be minimised, and ideally, the stems of the stalky material should not have collapsed. A measure of the structural integrity of the stalky material of the digestion enhancing forage material is obtained by determining the first and second compression specific gravities of the digestion enhancing forage material, as well as by determining the first and second compression specific gravities of the prepared feed. The higher the values of the first and second compression specific gravities of the digestion enhancing forage materials and the prepared feed are, the poorer will be the structural integrity of the stalky material of the digestion enhancing forage material. The lower the values of the first and second compression specific gravities of the digestion enhancing forage material and the prepared feed are, the better will be the structural integrity of the digestion enhancing forage material. However, the first and second compression specific gravities of the digestion enhancing forage material and in turn the prepared feed are subject to the predefined lower limit values so that the structural integrity of the stalky material is not such which would prevent deformation of the stalky material in the rumen as the normal digestion process progresses within the rumen.

Originally it was believed that the digestion enhancing forage material of the prepared feed formed a mat which floated on the surface of the rumen liquor within the rumen, thus retaining the nutritional ingredients floating on the surface of the rumen liquor and in turn preventing premature discharge of the nutritional ingredients from the rumen and initiating rumination events. However, further investigations have revealed that the digestion enhancing forage material of the prepared feed according to the invention actually forms the three-dimensional uniform homogenous low density open matrix which extends throughout the contents within the rumen, thus retaining the nutritional ingredients and other fibrous ingredients of the prepared feed dispersed throughout and retained within the matrix for maximising exposure of the nutritional ingredients and the other fibrous materials to the rumen liquor, and in particular, to enzymes and microflora within the rumen liquor. The discovery that the digestive enhancing forage material formed the homogenous low density open matrix throughout the rumen liquor within the rumen was made as a result of investigating the digestive process to which the prepared feed according to the invention was subjected within the rumen in greater depth, and in particular, by observing the digestive process to which the prepared feed according to the invention was subjected within the rumen of fistulated cows.

Mixing of the ingredients to produce the prepared feed is important, and it is particularly important that the ingredients are mixed to an extent that a homogenous mix of all the ingredients, both fibrous and particulate ingredients as well as liquid ingredients, and non-fibrous ingredients is prepared without under-mixing or over-mixing of the ingredients. In particular, it is important that over-mixing should be avoided in order to minimise any danger of deterioration of the structural integrity of the stalky materials which ultimately form the digestion enhancing forage material of the prepared feed. In general, many of the ingredients, particularly the fibrous materials, will be of length greater than the maximum preferred length, and thus, it is desirable that during mixing of the ingredients, those fibres which are of lengths greater than the desired length should be chopped. It has been found that by mixing the ingredients in a mixing apparatus which comprises a paddle type mixing rotor which is rotatable about a substantially horizontal axis provides a relatively light touch mix which minimises the risk of damage to the structural integrity of those forage ingredients which ultimately form the digestion enhancing forage material of the prepared feed. Such a mixing apparatus should also include a chopping function. Ideally, the prepared feed is mixed in a mixing apparatus of the type disclosed in PCT Published Application Specification No. WO 96/32836 of the present applicant and is sold under the trade names KEENAN KLASSIK, KEENAN KOMPACT and KEENAN PACE. In mixing the ingredients in such mixing apparatus, the appropriate size of mixing apparatus should be used for the batch size of the prepared feed being mixed. The mixing rotor typically is operated at a speed in the range of 6 rpm to 8 rpm, and preferably, at a rotational speed of the order of 8 rpm.

Providing the prepared feed in this manner with a dry matter content in the range of 30% to 70%, preferably in the range of 35% to 60%, and ideally in the range of 40 to 45%, and with substantially none of the stalky material in the prepared feed exceeding 80 mm minimises selective feeding by the ruminant, whereby the ruminant selectively partakes of the more palatable ingredients of the prepared feed and excludes the less palatable ingredients, such as the stalky material of the digestion enhancing forage material. By controlling the dry matter content of the prepared feed, it becomes more difficult for a ruminant to separate the more palatable ingredients from the less palatable ingredients, and furthermore, by providing the stalky material of the digestion enhancing forage material with stalks of length not exceeding 80 mm, it makes it virtually impossible for a ruminant to separate out the stalky material from the remainder of the prepared feed.

The provision of prepared feed according to the invention as a homogenously mixed feed optimises rumen function, resulting in an increased yield of intermediary products per unit feed consumed which promote weight gain and milk yield. Accordingly, the provision of the prepared feed according to the invention facilitates significant improvements in weight gain and milk yield without a commensurate increase in feed intake, and at the same time leads to reduced excretions of waste materials (faeces and urine) to the environment.

The invention will be more clearly understood from the following description of some preferred embodiments thereof, which are given by way of example only, with reference to the following non-limiting examples.

### EXAMPLES

TABLE 1
Prepared feed (% ration dry matter by weight):

| Ingredients | Example 1 | Example 2 | Example 3 | Example 4 |
|---|---|---|---|---|
| Grass silage | 57.7 | | 39.3 | 31.4 |
| Maize silage | | 58.8 | 14.5 | 6.7 |
| Whole crop | 11.5 | | | |
| wheat silage | | | | |
| Straw | 1.54 | 1.62 | 1.55 | 2.04 |
| Dairy Blend | 29.2 | 39.6 | 44.7 | 64.8 |

TABLE 2
Ruminant performance

| Performance | | | | |
|---|---|---|---|---|
| Characteristics | Example 1 | Example 2 | Example 3 | Example 4 |
| Feed Dry matter | 21.05 | 19.39 | 19.83 | 19.91 |
| intake kgs/d | | | | |
| Energy | 29.21 | 28.76 | 28.12 | 26.8 |
| corrected milk | | | | |
| yield kgs | | | | |
| FCE kgECM/kg | 1.39 | 1.48 | 1.42 | 1.35 |
| DM intake | | | | |

TABLE 3
Physical characteristics of the feed rations.

| Characteristics | Example 1 | Example 2 | Example 3 | Example 4 |
|---|---|---|---|---|
| PSE mls/ltr | 717.5 | 709.3 | 709.2 | 729.8 |
| SG | 226 | 220 | 218 | 209 |
| uncompressed | | | | |
| gms/ltr | | | | |
| SG Wt 1 gms/ltr | 293 | 281 | 225 | 200 |
| compressed | | | | |
| SG Wt2 gms/ltr | 421 | 284 | 338 | 319 |
| compressed | | | | |
| SG wetted | 646 | 657 | 599 | 598 |
| gms/ltr | | | | |
| uncompressed | | | | |

TABLE 4
Physical characteristics of the digestion enhancing forage material

| Characteristics | Example 1 | Example 2 | Example 3 | Example 4 |
|---|---|---|---|---|
| PSE mls/ltr | 694.9 | Not available | 761.0 | 803.3 |
| SGuncompressed | 194 | Not available | 157 | 145 |
| gms/ltr | | | | |
| SG Wt 1 gms/ltr | 273 | Not available | 169 | 155 |
| compressed | | | | |
| SG Wt2 gms/ltr | 481 | Not available | 309 | 301 |
| compressed | | | | |
| SG wetted | 716 | Not available | 606 | 548 |
| gms/ltr | | | | |
| uncompressed | | | | |
| Proportion of | 522 | 93 | 401 | 396 |
| prepared feed | | | | |
| gms per kg | | | | |

Table 1 sets out four examples of prepared feeds which have been prepared according to the invention. The ingredients of the prepared feeds of the respective examples are set forth in the first column of Table 1. The proportions of the ingredients of the prepared feeds of the respective examples are set forth in the next four columns as percentage of dry matter by weight of the prepared feeds. The ingredients of all four examples were mixed in a mixer/feeder wagon of the type disclosed in PCT Published Application Specification No. WO 96/32836 and sold under the trade name KEENAN KLASSIK, KEENAN KOMPACT or KEENAN PACE. The capacities of the mixer/feeder wagons were appropriate to the batch sizes of the prepared feeds being mixed. The ingredients were loaded into the appropriate mixer/feeder wagon in the order of the straw first, the dairy blends next and finally the silages, grass silage being loaded before maize silage. The dairy blends are concentrates which are high in nutritional and energy values and are of relatively small particle size. No liquids were added. The prepared feed of each example was subjected to an appropriate mixing period in the mixer/feeder wagon to produce a uniform homogenous mix of the prepared feed with approximately 85% to 90% of the fibres of the forage materials of the prepared feeds being of length not greater than 80 mm. This required mixing periods in the range of 80 revolutions of the mixing rotor to 200 revolutions of the mixing rotor of the mixer/feeder wagon, and more typically mixing periods in the range of 100 revolutions to 140 revolutions of the mixing rotor. In all cases the mixing rotor rotated at a speed of between six and eight revolutions per minute.

The prepared feeds of the four examples were analysed to establish the primary saturation extent, the uncompressed specific gravity, the first and second compression specific gravities and the wetted specific gravity of the prepared feeds of the four examples. The methods for determining the primary saturation extent, the uncompressed specific gravity, the first and second compression specific gravities and the wetted specific gravity of the prepared feeds of the four examples were as already described. The results of the analysis of the prepared feeds of the four examples are set forth in Table 3. The first line of Table 3 sets out the primary saturation extent of the prepared feeds in mls water per litre of the prepared feed, the uncompressed specific gravity of the prepared feeds are set out in the second line of Table 3 and is given in gms per litre. The first and second compression specific gravities of the prepared feeds are set out in gms per litre in the third and fourth lines of Table 3. The wetted specific gravity of the prepared feeds are set out in line 5 in gms per litre of Table 3.

The proportion of the prepared feeds of Examples 1, 3 and 4 which constitute a digestion enhancing forage material was determined, and the proportion is set forth in the last line of Table 4. While the proportion of the prepared feeds of Examples 1, 3 and 4 which is constituted by the digestion enhancing forage material is within the broad range of 100 gms per kg prepared feed to 550 gms per kg prepared feed, and while the proportion of the digestion enhancing forage material of the prepared feed of Example 2 falls just outside the lower limit of 100 gms per kg prepared feed of the broader range, it is believed that the digestion enhancing forage material should preferably constitute in the range of 180 gms per kg prepared feed to 240 gms per kg prepared feed. The reason the proportion of the prepared feed of Examples 1, 3 and 4 which is constituted by the digestion enhancing forage material appears to be in the high end of the broad range may be partly explained by the fact that the sampling was carried out in the field, and partly because the prepared feeds of Examples 1, 3 and 4 are relatively high, being grass silage.

The physical characteristics of the digestion enhancing forage material of the prepared feeds of Examples 1, 3 and 4 was analysed, and the physical characteristics, namely, the primary saturation extent, the uncompressed specific gravity, the first and second compression specific gravities and the wetted specific gravities of the digestion enhancing forage material of the prepared feeds of Examples 1, 3 and 4 are set forth in Table 4 in a similar manner as the physical characteristics of the prepared feeds of Examples 1 to 4 are set forth in Table 3.

The prepared feed of Example 1 was fed to a herd of lactating cows of live weight generally in the order of 600 kg to 650 kg. The cows were group fed a daily ration of approximately 35 gms of the prepared feed of Example 1 per kg live weight of the cow for a period of not less than ninety days.

The prepared feed of Example 2 was fed to a herd of lactating cows of live weight generally in the order of 600 kg to 650 kg. The cows were group fed a daily ration of approximately 35 gms of the prepared feed of Example 1 per kg live weight of the cow for a period of not less than ninety days.

The prepared feed of Example 3 was fed to a herd of lactating cows of live weight generally in the order of 600 kg to 650 kg. The cows were group fed a daily ration of approximately 35 gms of the prepared feed of Example 1 per kg live weight of the cow for a period of not less than ninety days.

The prepared feed of Example 4 was fed to a herd of lactating cows of live weight generally in the order of 600 kg to 650 kg. The cows were group fed a daily ration of approximately 35 gms of the prepared feed of Example 1 per kg live weight of the cow for a period of not less than ninety days.

The performance of the cows of the four herds which were fed with the prepared feeds of Examples 1 to 4 over the relevant periods was monitored. The performance characteristics which were monitored are set forth in Table 2. In line 1 of Table 2, the dry matter intake of the feed in kg per day is set forth for each of Examples 1 to 4. In line 2 of Table 2 the energy corrected milk yield in kg per day per cow from the respective herds which were fed with the prepared feed of Examples 1 to 4 is set forth. The feed conversion efficiency based on kg of energy corrected milk in kg per day per kg of feed per day per cow is set forth in line 3 of Table 2 for each of the herds which were fed with the prepared feeds of Examples 1 to 4.

Accordingly, from Tables 1 and 2 it can be seen that three of the four herds, namely, the herds which were fed with the prepared feeds of Examples 1, 3 and 4 were fed with feed rations containing relatively high levels of grass silage, with only the herd which was fed with the prepared feed of Example 2 being fed a feed ration high in maize silage, rather than grass silage. As expected, this herd which was fed the prepared feed of Example 2 had the highest feed conversion efficiency and the second highest energy corrected milk yield despite having the lowest feed intake. All four herds had very acceptable levels of milk production, with the possible exception of the herd which was fed with the prepared feed of Example 4. The prepared feed of Example 4 had the lowest forage to concentrate blend ratio.

The relatively modest levels of feed intake (mean, 20.04 kg dry matter per day) for all four herds resulted in good levels of milk production (mean, 27.72 kg energy corrected), indicating that desirable levels of performance can be achieved through higher feed conversion efficiencies. It was also noted that throughout the periods during which the herds were being fed with the respective prepared feeds of Examples 1 to 4, all the herds were relatively stable with respect to body condition, thus confirming that the levels of milk produced were achieved directly from feed consumed, and without any significant contribution from mobilised body tissue.

All four prepared feeds of Examples 1 to 4 included a significant amount of cereal straw which ultimately produced the digestion enhancing forage material. The mean amount of cereal straw as a percentage of dry matter of the prepared feeds was 1.69%. Thus, by mixing the ingredients in accordance with the method according to the invention, the prepared feeds were produced with a mean primary saturation extent of 716.5 gms water per litre prepared feed with a low mean uncompressed specific gravity of 218 gms per litre. Furthermore, the prepared feeds of Examples 1 to 4 had low mean first and second compression specific gravities of 250 gms per litre and 341 gms per litre, respectively, and a desirable mean specific gravity when wetted of 625 gms per litre.

The production of the prepared feeds of Examples 1 to 3 with the primary saturation extent, the uncompressed specific gravity, the first and second compression specific gravities and the wetted specific gravities result from the fact that the respective prepared feeds of Examples 1, 3 and 4 comprise the proportions of digestion enhancing forage material set forth in Table 4 with the primary saturation extent, the uncompressed specific gravity, the first and second compression specific gravities and the wetted specific gravities which are also set forth in Table 4.

Thus, the prepared feeds of Examples 1 to 4 which comprise the required amount of digestion enhancing forage material promote good levels of milk production at relatively modest levels of feed intake through improved feed conversion efficiency.

1-139. (canceled)

140. A prepared feed for a ruminant produced by mixing a plurality of ingredients, the prepared feed comprising forage material, and at least some of the forage material acting to enhance digestion of the prepared feed by the ruminant, the proportion of the digestion enhancing forage material in the prepared feed being such that the prepared feed has:
a primary saturation extent in the range of 675 mls water per litre of prepared feed to 735 mls water per litre of prepared feed,
an uncompressed specific gravity in the range of 200 gms per litre to 280 gms per litre, and
a first compression specific gravity in the range of 180 gms per litre to 300 gms per litre when subjected to a first downward compressive force of 2.41 kg in a vertically oriented cylindrical container having an internal diameter of 75 mm.

141. A prepared feed as claimed in claim 140 in which the uncompressed specific gravity of the prepared feed lies in the range of 210 gms per litre to 260 gms per litre, and the first compression specific gravity of the prepared feed lies in the range of 220 gms per litre to 290 gms per litre.

142. A prepared feed as claimed in claim 140 in which the prepared feed has a second compression specific gravity in the range of 270 gms per litre to 430 gms per litre when subjected to a second downward compressive force of 7.41 kg in the vertically oriented cylindrical container having an internal diameter of 75 mm.

143. A prepared feed as claimed in claim 140 in which the uncompressed specific gravity of the prepared feed after wetting thereof resulting from a test to determine the primary saturation extent of the prepared feed lies in the range of 590 gms per litre to 660 gms per litre.

144. A prepared feed as claimed in claim 140 in which the length of fibres of the forage material of the prepared feed does not exceed 100 mm, the length of some of the fibres of the forage material of the prepared feed lies in the range of 30 mm to 50 mm, and the length of some of the fibres of the forage material of the prepared feed lies in the range of 50 mm to 80 mm.

145. A prepared feed as claimed in claim 140 in which the primary saturation extent of the digestion enhancing forage material of the prepared feed lies in the range of 680 mls water per litre of digestion enhancing forage material to 820 mls water per litre of digestion enhancing forage material, the uncompressed specific gravity of the digestion enhancing forage material lies in the range of 100 gms per litre to 220 gms per litre, and the first compression specific gravity of the digestion enhancing forage material lies in the range of 140 gms per litre to 290 gms per litre when the digestion enhancing forage material is subjected to the first downward compressive force of 2.41 kg in the vertically oriented cylindrical container having an internal diameter of 75 mm.

146. A prepared feed as claimed in claim 145 in which the uncompressed specific gravity of the digestion enhancing forage material of the prepared feed after wetting thereof resulting from a test to determine the primary saturation extent of the digestion enhancing forage material lies in the range of 530 gms per litre to 740 gms per litre.

147. A prepared feed as claimed in claim 140 in which the digestion enhancing forage material has a second compression specific gravity in the range of 150 gms per litre to 500 gms per litre when the digestion enhancing forage material is subjected to the second downward compressive force of 7.41 kg in the vertically oriented cylindrical container having an internal diameter of 75 mm.

148. A prepared feed as claimed in claim 140 in which the length of the fibres of the digestion enhancing forage material does not exceed 100 mm, the length of some of the fibres of the digestion enhancing forage material lies in the range of 30 mm to 50 mm, and the length of some of the fibres of the digestion enhancing forage material lies in the range of 50 mm to 80 mm.

149. A prepared feed as claimed in claim 140 in which the digestion enhancing forage material is derived from one or more of the following forage ingredients:
cereal straws
legume straws
canola/rape straws
cereal hays
legume hays
grass hays
corn stalks/stover
other suitable stalky materials according to local availability.

150. A prepared feed as claimed in claim 140 in which the digestion enhancing forage material constitutes in the range of 100 gms per kg of prepared feed to 550 gms per kg of prepared feed.

151. A prepared feed as claimed in claim 140 in which the digestion enhancing forage material is stalky material.

152. A digestion enhancing forage material for a prepared feed for a ruminant, the digestion enhancing forage material having:
a primary saturation extent in the range of 680 mls water per litre of prepared feed to 820 mls water per litre of prepared feed,
an uncompressed specific gravity in the range of 100 gms per litre to 220 gms per litre, and
a first compression specific gravity in the range of 140 gms per litre to 290 gms per litre when subjected to a first downward compressive force of 2.41 kg in a vertically oriented cylindrical container having an internal diameter of 75 mm.

153. A digestion enhancing forage material as claimed in claim 152 in which the uncompressed specific gravity of the digestion enhancing forage material of the prepared feed after wetting thereof resulting from a test to determine the primary saturation extent of the digestion enhancing forage material lies in the range of 530 gms per litre to 740 gms per litre.

154. A digestion enhancing forage material as claimed in claim 152 in which the digestion enhancing forage material has a second compression specific gravity in the range of 150 gms per litre to 500 gms per litre when the digestion enhancing forage material is subjected to the second downward compressive force of 7.41 kg in the vertically oriented cylindrical container having an internal diameter of 75 mm.

155. A digestion enhancing forage material as claimed in claim 152 in which the length of the fibres of the digestion enhancing forage material does not exceed 100 mm, the length of some of the fibres of the digestion enhancing forage material lies in the range of 30 mm to 50 mm, and the length of some of the fibres of the digestion enhancing forage material lies in the range of 50 mm to 80 mm.

156. A digestion enhancing forage material as claimed in claim 152 in which the digestion enhancing forage material is derived from one or more of the following forage ingredients:
cereal straws
legume straws
canola/rape straws
cereal hays
legume hays
grass hays
corn stalks/stover
other suitable stalky materials according to local availability.

157. A method for producing a prepared feed for a ruminant, the method comprising mixing a plurality of ingredients of which at least one of the ingredients comprises forage material, and at least some of the forage material acts to enhance digestion of the prepared feed by the ruminant, the proportion of the digestion enhancing forage material in the prepared feed being such that the prepared feed has:
a primary saturation extent in the range of 675 mls water per litre of prepared feed to 735 mls water per litre of prepared feed,
an uncompressed specific gravity in the range of 200 gms per litre to 280 gms per litre, and
a first compression specific gravity in the range of 180 gms per litre to 300 gms per litre when subjected to a first downward compressive force of 2.41 kg in a vertically oriented cylindrical container having an internal diameter of 75 mm.

158. A method as claimed in claim 157 in which the prepared feed has a second compression specific gravity in the range of 270 gms per litre to 430 gms per litre when subjected to a second downward compressive force of 7.41 kg in the vertically oriented cylindrical container having an internal diameter of 75 mm.

159. A daily feed ration for a ruminant comprising not more than 45 gms dry matter of the prepared feed as claimed in claim 140 per kg live weight of the ruminant.
